(19) United States
(12) Patent Application Publication
(10) Pub. No.: US 2005/0066526 A1
(43) Pub. Date: Mar. 31, 2005

(54) Shaving aid delivery system

(75) Inventor: Raymond Guimont, Guilford, CT (US)

Correspondence Address: MCCORMICK, PAULDING & HUBER LLP, CITY PLACE II, 185 ASYLUM STREET, HARTFORD, CT, 06103, US

(73) Assignee: Eveready Battery Company, Inc., St. Louis, MO (US)

(21) Appl. No.: 10/919,594

(22) Filed: Aug. 17, 2004

Related U.S. Application Data
(60) Provisional application No. 60/496,249, filed on Aug. 19, 2003.

(51) Int. Cl. B26B 19/44

(52) U.S. Cl. 30/41

(57) ABSTRACT

A shaving aid delivery material for use in a shaving implement comprises at least one layer of binder material having a plurality of microspheres embedded therein. Each of the microspheres defines an interior area containing shaving aid that may be applied to a user's skin surface. During a shaving operation, at least a portion of the microspheres degrade to release the shaving aids from the interior area onto the skin surface. Multiple shaving aid layers containing binder material and microspheres may be laminated together, and may further include additional film or barrier layers separating the shaving aid layers.

### CROSS-REFERENCE TO RELATED APPLICATIONS

This application is entitled to the benefit of and incorporates by reference essential subject matter disclosed in Provisional Patent Application No. 60/496,249 filed on Aug. 19, 2003.

### FIELD OF THE INVENTION

The present invention is generally directed to the delivery of one or more shaving aids onto a user's skin during a shaving operation, and is more specifically directed to the use of encapsulation and microencapsulation technology, such as microcapsules, microspheres, vesicles and nanospheres, as a shaving aid storage and delivery vehicle.

### BACKGROUND OF THE INVENTION

As used herein, the term “shaving aid” is to be broadly construed to include shaving creams, soaps, gels, aloe and foams, as well as any other pre-, mid- or post-shaving skin preparations, such as, but not limited to, lotions, aftershaves, perfumes, balms, razor cleaners, whisker softeners, vitamin containing substances or other cosmetic and medicinal skin applications, and combinations thereof.

Over the years, many improvements have been made to razors in order to make such razors more comfortable to use and more efficient at their intended task. Towards this end, many wet shaving razors now employ shaving aids applied before, during and/or after shaving. Shaving aids are applied to the skin surface for various reasons. For example, shaving cream, soap, gel or foam is typically applied by a user prior to shaving to soften the hair to be cut and to lubricate the skin surface. Lotions, balms and other medicinal skin application are often used to relieve skin irritation caused by shaving. Perfumes and other scented aftershaves are often applied after shaving.

Shaving aid preparations are typically applied to the skin surface in several ways: (1) via manual application of gels, creams or lotions before or after shaving; (2) through lubrication or comfort strips attached to the razors; or (3) with devices added to the razor assembly that deliver materials through conventional means such as aerosols, squeeze tubes, pumps and the like.

Conventional methods of applying shaving aids to the user's skin have drawbacks that affect the application of the shaving aids and the shaving performance of the razors with which such shaving aids are used. Existing lubrication or comfort strips have provided advantages over other known shaving aid delivery methods by being attached to the razor cartridge, typically proximate the razor blades, and applying shaving aid during a shaving operation. However, release of shaving aid from such strips is difficult to control both during a shaving operation and through the life of the razor cartridge. The shaving aid preparations embodied in such strips can be unstable under varying conditions, and are often difficult to apply to the skin in a consistent and efficient manner, especially as the strip wears away. Further, the provision of shaving aid in many of the existing methods often interferes with the effectiveness of the razor by, for example, creating excess waste and shaving debris, or relying on a liquid preparation that clogs the razor cartridge and blocks the razor blades.

There exists a need in the art for a more efficacious means of dispensing shaving aids that not only accomplishes the objective of lubricating, soothing or treating the hair and skin surface, but also one which may be provided in a more controlled and efficient fashion, in greater amounts than with the known delivery systems, and in a variety of formulations to satisfy personal needs for the user.

With the foregoing problems and concerns in mind, it is the general object of the present invention to provide a shaving aid delivery system which overcomes or improves upon the above-described drawbacks.

### SUMMARY OF THE INVENTION

The present invention resides in a first aspect in a shaving aid delivery material comprising at least one layer of binder material having a plurality of microspheres embedded therein. Each of the microspheres defines an interior area containing shaving aid, and at least a portion of the microspheres being degradable so that the shaving aids contained therein are released onto the skin of a user during a shaving operation.

The present invention resides in a second aspect in a shaving implement comprising a handle portion, a razor cartridge attached thereto and defining at least one cutting edge for cutting hair from a hirsute surface, and a comfort strip, or lubrication strip, coupled to the razor cartridge. The comfort strip is defined by at least one layer of binder material having a plurality of microspheres embedded therein. Each of the microspheres defines an interior area containing shaving aid, and at least a portion of the microspheres being degradable during a shaving operation so as to release any shaving aids from said interior area onto the skin of a user. The comfort strip may be positioned on the razor cartridge before, between, or after the blades, or anywhere on the razor cartridge that would allow the strip to contact the user's skin during a shaving operation. Additionally, multiple strips may be provided on the razor cartridge, each strip having a plurality of microspheres embedded therein.

The present invention provides an efficient storage and delivery system for shaving aids during pre-shave, mid-shave and post-shave operations that improve shaving performance and comfort. Additional advantages provided by the present invention include controlled or metered release of shaving aid materials, increased amounts of shaving aid provided to the user, protection of shaving aid compositions until time of release, extended shelf life of the shaving aid and/or the razor, and increased variety of shaving aid formulations provided to consumers.

### BRIEF DESCRIPTION OF THE DRAWINGS

FIG. 1 is a partial perspective view of a multilayered material, each layer containing a plurality of microspheres embedded therein.

FIG. 2 is a partial perspective view of a single layer of material that includes a plurality of microspheres of varying sizes embedded therein.

FIG. 3 is a partial perspective view of a laminated material wherein a film layer is interposed between other layers of material having a plurality of microspheres embedded therein.

FIG. 4 is a partial perspective view of a material wherein layers of material having a plurality of microspheres embedded therein have layers of barrier material interposed therebetween.

FIG. 5 is a perspective view of a shaving implement having material containing microspheres, in accordance with the present invention, coupled to a razor cartridge.

### DETAILED DESCRIPTION OF THE PREFERRED EMBODIMENTS

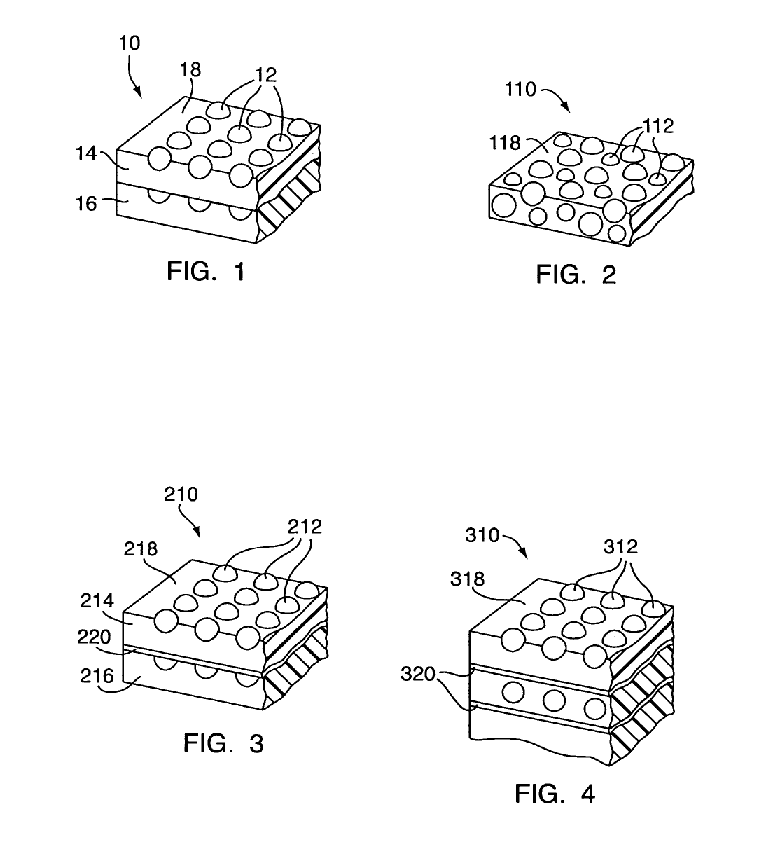

As shown in FIG. 1, the present invention is directed to a material generally designated by the reference number 10 that includes a plurality of microspheres 12, each defining an interior area (not shown) that is at least partially filled with a shaving aid. The material 10 is shown in the illustrated embodiment as being composed of two layers 14 and 16, however, the present invention is not limited in this regard as any number of layers can be employed without departing from the broader aspects of the present invention. The microspheres 12 are embedded in a matrix of binder material 18. As will be explained in detail herein below, the material 10 is attachable to a razor cartridge forming part of a razor.

The binder material 18 also acts as a shaving aid and is preferably formed from a shaving aid preparation that works in combination with the shaving aid preparation provided in the microspheres to improve the efficiency and performance of the razor. Typically, the binder material 18 comprises a polymer or copolymer binder. The binder material 18 is preferably formed from, but is not limited to polyurethane hydrogel, polyvinylpyrrolidone and vinyl acetate copolymers, polyethylene oxide, carboxymethyl hydroxypropyl guar, ethylene vinyl acetate (EVA)-wax, ester of montanic acids, or hot melt adhesives. During a shaving operation, abrasion causes the binder material 18 to wear, thereby exposing the microspheres 12. Alternatively, the binder material 18 can be at least partially soluble so that when exposed to moisture as a user shaves, the binder dissolves at a rate sufficient to expose the microspheres 12 to the user's skin.

Similar to the binder material 18, the microsphere material is also preferably of a character such that abrasion resulting from the microspheres 12 being drawn over a hirsute surface causes the microspheres to rupture, thereby allowing the shaving aid contained therein to flow onto the user's skin. Alternately, the microspheres 12 can be formed from a semi-soluble material that dissolves when exposed to a moist environment, or from a material that reacts to a pH level or a temperature. Preferably, the microspheres 12 are formed from urea formaldehyde, urea formaldehyde modified with melamine, gelatin, gelatin coaceravate, polyoxymethylene urea (PMU), agar or metholphenols. As previously noted, the interior areas of the microspheres 12 are at least partially filled with a shaving aid preparation.

The present invention is adaptable, in general, to encapsulation and microencapsulation technology. That is, the reference to “microspheres” generally comprises microcapsules, vesicles and nanospheres, in addition to microspheres.

Still referring to FIG. 1, the microspheres 12 each define an equivalent spherical diameter approximately equal to a thickness defined by the layers 14,16 in which they are embedded. Though shown as having substantially uniform size, the microspheres 12 may have varying sizes. Preferably, the microspheres 12 have an equivalent spherical diameter within the range of about 1 to about 400 microns. More preferably, the microspheres 12 have an equivalent spherical diameter within the range of about 10 to about 40 microns. Additionally, the thickness of the layers 14, 16 may be uniform or vary. The overall thickness of the comfort strip may be adjusted by using any number of layers having various thicknesses, or one single layer with microspheres dispersed throughout the layer. Preferably, the comfort strip has a thickness between about 1 to about 100 mils, and more preferably a thickness between about 1 to about 30 mils.

The microspheres 12 may be arranged within each binder layer 18 in an array, as is shown in FIG. 1, or randomly distributed throughout the binder layer 18. The concentration of microspheres 12 within the binder material 18 may also be varied. Thus, it is possible for an individual to customize the shaving aid formulation of a comfort strip used on a razor. Preferably, each layer of material 10 is loaded with microspheres 12 in a concentration range of about 1 to about 60 percent. More preferably, the concentration of microspheres 12 is in the range of about 10 to about 40 percent.

The microspheres 12 can all contain the same shaving aid preparation, or different microspheres 12 can contain different shaving aid preparations. Moreover, the microspheres 12 forming part of one layer of the material 10 can all contain one shaving aid preparation while the microspheres 12 forming part of another layer of the material 10 can contain a different shaving aid preparation.

A second embodiment of the material of the present invention, shown in FIG. 2, is generally designated by the reference numeral 110. The material 110 is similar in many respects to the material 10 described above, and therefore like reference numerals preceded by the number 1 are used to indicate like elements. The material 110 is extrudable and preferably includes a low temperature binder material 118. As used herein, the term low temperature should be broadly construed to mean that the extrusion temperature of the binder material 118 is below approximately 135° C. At such an extrusion temperature, the microspheres will not degrade, nor will the shaving aid contained therein be damaged.

As is readily observed, the material 110 is a single layer material, which, in the illustrated embodiment, includes a plurality of microspheres 112 of varying size. The differently sized microspheres 112 allow for tighter packing of the microspheres in the binder material 118, thereby allowing for more shaving aid to be delivered to a user's skin during a shaving operation. However, while differently sized microspheres 112 have been shown and described, the present invention is not limited in this regard as microspheres having substantially the same size can also be employed without departing from the broader aspects of the present invention. Moreover, while a single layer of material 110 has been shown and described, the present invention is not limited in this regard as more than one extruded layer of material can be employed.

A third embodiment of the material of the present invention, shown in FIG. 3, is generally designated by the reference numeral 210. The material 210 is similar in many respects to the material 10 described above, and therefore like reference numerals preceded by the number 2 are used to indicate like elements. The material 210 differs from the material 10 in that a layer of film 220 is interposed between successive layers containing binder 218 and microspheres 212. During a shaving operation, as a layer containing binder 218 and microspheres 212 is depleted, a user then peels the film 220 off to expose a fresh layer. Alternatively, the film 220 may be made from a material that is at least partially soluble in a moist or wet environment, or which may be abradable when drawn across a user's skin. The material 210 could be fabricated by coating a wide layer of binder/microspheres slurry, cuffing the layer into strips and stacking the strips on top of one another with film layers 220 between successive strips.

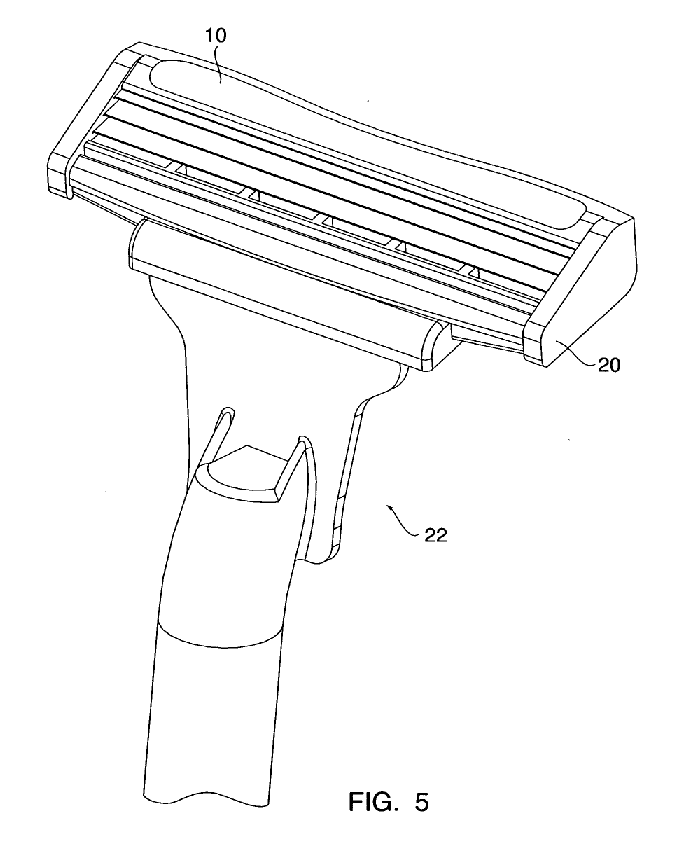

A fourth embodiment of the material of the present invention, shown in FIG. 4, is generally designated by the reference numeral 310. The material 310 is similar in many respects to the material 210 described above, and therefore like reference numerals preceded by the number 3 are used to indicate like elements. The material 310 differs from the material 210 in that a barrier layer of material 320 is interposed between successive layers containing binder 318 and microspheres 312. The barrier layer 320 is made from a suitable material that is at least partially soluble in a moist or wet environment and which may also be abradable when drawn across a user's skin. In addition, the thickness defined by the barrier layers 320 can be varied as well as the solubility of the barrier layers in order to control the rate of degradation during a shaving operation. In addition, the barrier layers 320 can include adhesive properties for binding the material 310 together.

The layers and laminates for the embodiments discussed above can be processed using any of several known coating processes, including, but not limited to, gravure coating, knife coating, die or extrusion coating, hot melt binder coating, or combinations of various coating methods. For example, with reference to the embodiment of FIG. 1, a slurry containing the binder material 18 and the microspheres 12 may be coated onto a carrier substrate using a direct gravure coating process. A relatively coarse gravure roll rotates through a container of the slurry, where the slurry fills up the gravure cells. Excess slurry is doctored off using a doctor blade. The carrier substrate contacts the gravure roll and a substantial portion of the slurry is transferred to the carrier substrate. The slurry layer is then oven-dried. A water soluble-film 220 or a barrier varnish layer 320, as shown in FIGS. 3 and 4, may be applied to the slurry layer after it is dried. Dried layers of slurry material, or laminates of slurry layer and film or barrier layer may be used as the carrier substrate to achieve laminates of desired thickness.

An alternate process that may be used to create the layers or laminates of the present invention is a knife-over-roll coating process. This coating process allows for a higher viscosity slurry material that is created in one thick continuous layer. The thickness of the material is dictated by the amount of clearance between the coating knife and the base roll or plate.

Additional processes that may be used to create the layers or laminates of the present invention are slot die or extrusion coating processes. A solid layer of slurry material is pumped or extruded through dies, rollers or other openings having predetermined shapes and thicknesses. Typically, the material is heated to modify the viscosity so that the material will flow through the opening.

As shown in FIG. 5, the material 10 is attached to a razor cartridge 20 forming part of a razor generally designated by the reference numeral 22. While the material 10 is shown attached to an upper portion of the razor cartridge 20, the present invention is not limited in this regard. The material 10 can be attached anywhere on the razor cartridge 20 that would allow the material to contact a user's skin during a shaving operation. For example, the material 10 may act as a comfort strip, a lubrication strip or a guard bar. It may be positioned before, between or after the blades. More than one strip of the material 10 may be provided on the razor cartridge 20, and each strip may contain a different shaving aid depending on its location on the razor cartridge 20. When the material 10 contacts the user's skin, the shaving aid is preferably released from the microspheres embedded within the material onto the skin, for example, by abrasion of the microspheres and binder material as described above. The material 10 wears during each shaving operation. The amount of material 10 provided on each razor cartridge 20 may be coordinated with the desired life of the razor cartridge 20. That is, the wearing away of the material 10 can match the expected life of the razor blades so as to minimize wasted shaving aid. Similarly, the amount of material 10 provided can be such that the shaving aid will be consistently applied to the user's skin throughout the intended life of the razor cartridge 20.

While preferred embodiments have been shown and described, one skilled in the pertinent art to which the present invention pertains will immediately recognize that various modifications and substitutions may be made. Accordingly, it is to be understood that the present invention has been described by way of example, and not by limitation.

1. A shaving aid delivery material comprising:
at least one layer of binder material having a plurality of microspheres embedded therein;
each of said microspheres defining an interior area containing shaving aid; and
at least a portion of said microspheres being degradable so that the shaving aids contained therein are released onto the skin of a user during a shaving operation.

2. The shaving aid delivery material of claim 1, wherein the microspheres have an equivalent spherical diameter in the range of about 1 to about 400 microns.

3. The shaving aid delivery material of claim 2, wherein the microspheres have an equivalent spherical diameter in the range of about 10 to about 40 microns.

4. The shaving aid delivery material of claim 1, wherein the layer of binder material is loaded with microspheres in the range of about 1 to about 60 percent of the combined binder material and microspheres.

5. The shaving aid delivery material of claim 4, wherein the layer of binder material is loaded with microspheres in the range of about 10 to about 40 percent of the combined binder material and microspheres.

6. The shaving aid delivery material of claim 1, wherein the binder material is an abrasively degradable binder material.

7. The shaving aid delivery material of claim 1 wherein the binder material is a water soluble binder material.

8. The shaving aid delivery material of claim 1, wherein the binder material comprises at least one of polyurethane hydrogel, polyethylene oxide, carboxymethyl hydroxypropyl guar, ethylene vinyl acetate, ester of montanic acids, and a copolymer of polyvinylpyrrodidone and vinyl acetate.

9. The shaving aid delivery material of claim 1, wherein the microspheres are abrasively degradable.

10. The shaving aid delivery material of claim 1, wherein the microspheres comprise at least one of urea formaldehyde, urea formaldehyde modified with melamine, gelatin, gelatin coaceravate, polyoxymethylene urea, agar and metholphenol.

11. The shaving aid delivery material of claim 1, wherein each said layer of binder material includes a first plurality of the microspheres containing a first shaving aid and a second plurality of the microspheres containing a second shaving aid.

12. The shaving aid delivery material of claim 1, comprising multiple layers of binder material, each layer having a plurality of said microspheres embedded therein.

13. The shaving aid delivery material of claim 12, further comprising a film layer disposed on at least one surface of each said layer of binder material.

14. The shaving aid delivery material of claim 13, said film layer being removable when exposed.

15. The shaving aid delivery material of claim 14, said film layer being an abrasively degradable material.

16. The shaving aid delivery material of claim 14, said film layer being a water soluble material.

17. The shaving aid delivery material of claim 1, wherein the microspheres have substantially the same size.

18. The shaving aid delivery material of claim 1, wherein the microspheres are uniformly arrayed within the binder material.

19. The shaving aid delivery material of claim 1, wherein the microspheres are randomly distributed throughout the binder material.

20. The shaving aid delivery material of claim 1, wherein the microspheres are water soluble.

21. The shaving aid delivery material of claim 1, wherein the microspheres degrade in reaction to a predefined pH level.

22. The shaving aid delivery material of claim 1, wherein the microspheres degrade in reaction to a predefined temperature.

23. A shaving aid delivery laminate comprising:
a first layer of binder material having a plurality of microspheres embedded therein;
a second layer of binder material having a plurality of microspheres embedded therein; and
an intermediate layer disposed between the first layer and the second layer;
each of the microspheres defining an interior area containing shaving aid; and wherein
further wherein during a shaving operation, the first layer degrades releasing any shaving aids from the interior area of said microspheres embedded within said first layer, and thereby exposing the intermediate layer, said intermediate layer being removable when substantially exposed to expose the second layer.

24. The shaving aid delivery laminate of claim 23, wherein the microspheres have an equivalent spherical diameter in the range of about 1 to about 400 microns.

25. The shaving aid delivery laminate of claim 24, wherein the microspheres have an equivalent spherical diameter in the range of about 10 to about 40 microns.

26. The shaving aid delivery laminate of claim 23, wherein the layer of binder material is loaded with microspheres in the range of about 1 to about 60 percent of the combined binder material and microspheres.

27. The shaving aid delivery laminate of claim 26, wherein the layer of binder material is loaded with microspheres in the range of about 10 to about 40 percent of the combined binder material and microspheres.

28. The shaving aid delivery laminate of claim 23, wherein the binder material is an abrasively degradable binder material.

29. The shaving aid delivery laminate of claim 23, wherein the binder material comprises at least one of polyurethane hydrogel, polyethylene oxide, carboxymethyl hydroxypropyl guar, ethylene vinyl acetate, ester of montanic acids, and a copolymer of polyvinylpyrrodidone and vinyl acetate.

30. The shaving aid delivery laminate of claim 23, wherein the microspheres are abrasively degradable.

31. The shaving aid delivery laminate of claim 23, wherein the microspheres comprise at least one of urea formaldehyde, urea formaldehyde modified with melamine, gelatin, gelatin coaceravate, polyoxymethylene urea, agar and metholphenol.

32. The shaving aid delivery laminate of claim 23, wherein each layer of binder material includes a first plurality of the microspheres containing a first shaving aid and a second plurality of the microspheres containing a second shaving aid.

33. The shaving aid delivery laminate of claim 23, wherein the microspheres in the first layer of binder material contain a first shaving aid and the microspheres in the second layer of binder material contain a second shaving aid.

34. The shaving aid delivery laminate of claim 23, wherein the microspheres have substantially the same size.

35. The shaving aid delivery laminate of claim 23, wherein the microspheres are uniformly arrayed within each layer of binder material.

36. The shaving aid delivery laminate of claim 23, wherein the microspheres are randomly distributed throughout each layer of binder material.

37. The shaving aid delivery laminate of claim 23, wherein the binder material is a water soluble binder material.

38. The shaving aid delivery laminate of claim 23, wherein the microspheres are water soluble.

39. The shaving aid delivery laminate of claim 23, wherein the microspheres degrade in reaction to a predefined pH level.

40. The shaving aid delivery laminate of claim 23, wherein the microspheres degrade in reaction to a predefined temperature.

41. The shaving aid delivery laminate of claim 23, the intermediate layer being an abrasively degradable material.

42. The shaving aid delivery laminate of claim 23, the intermediate layer being a water soluble material.

43. A shaving implement comprising:
a handle portion and a razor cartridge attached thereto and defining at least one cuffing edge for cuffing hair from a hirsute surface;
a comfort strip coupled to said razor cartridge, said comfort strip being defined by at least one layer of binder material having a plurality of microspheres embedded therein; and
each of said microspheres defining an interior area containing shaving aid, and at least a portion of said microspheres being degradable during a shaving operation so as to release any shaving aids from said interior area onto the skin of a user.

44. The shaving implement of claim 43, wherein the microspheres have an equivalent spherical diameter in the range of about 1 to about 400 microns.

45. The shaving implement of claim 44, wherein the microspheres have an equivalent spherical diameter in the range of about 10 to about 40 microns.

46. The shaving implement of claim 43, wherein the layer of binder material is loaded with microspheres in the range of about 1 to about 60 percent of the combined binder material and microspheres.

47. The shaving implement of claim 46, wherein the layer of binder material is loaded with microspheres in the range of about 10 to about 40 percent of the combined binder material and microspheres.

48. The shaving implement of claim 43, wherein the binder material is an abrasively degradable binder material.

49. The shaving implement of claim 43, wherein the binder material comprises at least one of polyurethane hydrogel, polyethylene oxide, carboxymethyl hydroxypropyl guar, ethylene vinyl acetate, ester of montanic acids, and a copolymer of polyvinylpyrrodidone and vinyl acetate.

50. The shaving implement of claim 43, wherein the microspheres are abrasively degradable.

51. The shaving implement of claim 43, wherein the microspheres comprise at least one of urea formaldehyde, urea formaldehyde modified with melamine, gelatin, gelatin coaceravate, polyoxymethylene urea, agar and metholphenol.

52. The shaving implement of claim 43, comprising multiple layers of binder material, each layer having a plurality of said microspheres embedded therein.

53. The shaving implement of claim 52, further comprising a film layer disposed on at least one surface of each said layer of binder material.

54. The shaving implement of claim 53, said film layer being removable when exposed.

55. The shaving implement of claim 54, said film layer being an abrasively degradable material.

56. The shaving implement of claim 54, said film layer being a water soluble material.

57. The shaving implement of claim 43, wherein the microspheres have substantially the same size.

58. The shaving implement of claim 43, wherein the microspheres are uniformly arrayed within the binder material.

59. The shaving implement of claim 43, wherein the microspheres are randomly distributed throughout the binder material.

60. The shaving implement of claim 43, wherein the binder material is a water soluble binder material.

61. The shaving implement of claim 43, wherein the microspheres are water soluble.

62. The shaving implement of claim 43, wherein the microspheres degrade in reaction to a predefined pH level.

63. The shaving implement of claim 43, wherein the microspheres degrade in reaction to a predefined temperature.

64. The shaving implement of claim 43, wherein each said layer of binder material includes a first plurality of the microspheres containing a first shaving aid and a second plurality of the microspheres containing a second shaving aid.
